(19) United States
(12) Patent Application Publication
(10) Pub. No.: US 2016/0062185 A1
(43) Pub. Date: Mar. 3, 2016

(54) Display Device Having Alignment Structure and Assembly Method Thereof

(71) Applicant: AU OPTRONICS CORPORATION, Hsin-Chu (TW)

(72) Inventors: Chu-Hung Cheng, Hsin-Chu (TW); Ya-Wei Deng, Hsin-Chu (TW)

(21) Appl. No.: 14/747,123

(22) Filed: Jun. 23, 2015

(30) Foreign Application Priority Data
Aug. 26, 2014 (TW) 103129344

(51) Int. Cl. G02F 1/1335; G02F 1/1333

(52) U.S. Cl. CPC G02F 1/133608; G02F 1/13338; G02F 2001/133354

(57) ABSTRACT

A display device and an assembly method of the display device are provided. The display device includes a backlight module, a display panel, a cover lens, and an alignment mark. The backlight module has a supporting frame, and at least one alignment hole is formed on the supporting frame. The display panel is disposed on the backlight module and has a first substrate. The cover lens covers an outer side of the display panel opposite to the backlight module and protrudes outside a side edge of the first substrate. The alignment mark is formed on the first substrate or on the cover lens. The alignment mark at least partially overlaps the alignment hole within a vertical projecting region of the supporting frame. The relative positions along each part of the display device are ensured by using the alignment mark and the alignment hole.

### BACKGROUND OF THE INVENTION

1. Field of the Invention

The present invention relates to a display device and an assembly method thereof; particularly, the present invention relates to a display device having the alignment structure and an assembly method of the display device.

2. Description of the Prior Art

In addition to product design, the assembly of a display device is an important part that will influence the yield of product. In the traditional procedure of assembling the display device, a display panel is combined with a backlight module, and then a cover lens, located at the outer side, is disposed on the display panel. However, in the assembling procedure mentioned above, in order to maintain flatness of the interface between the display panel and the cover lens, a glue layer having a certain thickness is required to be distributed onto the display panel, and which is unfavorable to the whole thickness of the display device.

With the improvement of the assembling procedure, the assembling procedure for some display devices changes to combine the display panel with the cover lens, and then the combined display panel and cover lens is combined with the backlight module. By attaching the display panel to the cover lens in advance, the flatness between the display panel and the cover lens will be improved, and the thickness of the glue layer between the display panel and the cover lens can be reduced, so that the whole thickness of the display device is much thinner.

However, in the aforementioned assembling method that combines the display panel and the cover lens in advance, a problem may occur while the combined display panel and cover lens is combined with the backlight module. Since the cover lens has a larger dimension in length and width, the cover lens will block edges of the display panel while the combined display panel and the cover lens is combined with the backlight module. This situation will cause difficulty in confirming the relative position between a lower substrate of the display panel and a side wall of the backlight module by eyesight of an assembling personnel. This problem often causes the lower substrate pressing the sidewall of the backlight module, leading to damage of the lower substrate and influencing the yield of the display device. Therefore, the assembling method adopted by the current display device need to be improved.

### SUMMARY OF THE INVENTION

It is an object of the present invention to provide a display device which can enhance an accuracy of assembling a display panel.

It is another object of the present invention to provide an assembling method of the display device. The display device has an alignment design for reducing damage to the display panel during production.

The display device includes a backlight module, a display panel, a cover lens, and an alignment mark. The backlight module has a supporting frame, and at least one alignment hole is formed on the supporting frame. The display panel is disposed on the backlight module and has a first substrate. The cover lens covers an outer side of the display panel opposite to the backlight module and protrudes outside a side edge of the first substrate. The alignment mark is formed on the first substrate or on the cover lens. The alignment mark at least partially overlaps the alignment hole within a vertical projecting region of the supporting frame.

The assembly method of the display device includes: forming an alignment mark on a first substrate or on a cover lens; attaching the cover lens on an outer side of the display panel to allow the cover lens to protrude outside a side edge of the first substrate; forming at least one alignment hole on a supporting frame of a backlight module; moving the combined display panel and the cover lens above the backlight module, and inspecting the position of the alignment mark by the alignment hole to position the relative position of the display panel and the supporting frame; combing the display panel with the backlight module after positioning is completed; covering an opening formed by the alignment hole on a bottom surface of the supporting frame by a tape after the display panel and the backlight module are combined. By this method, the position of the alignment mark can be confirmed by utilizing the alignment hole of the backlight module so that the assembling yield of the display device can be enhanced.

### BRIEF DESCRIPTION OF THE DRAWINGS

FIG. 1 is an exploded view of a display device of the present invention;

FIG. 2 is a cross-sectional view of an embodiment of the display device of the present invention;

FIGS. 3A to 3C are schematic views of different embodiments of an alignment mark;

FIG. 4 is a schematic view of the display device shown in FIG. 2 that is covered by a tape;

FIGS. 5A and 5B are cross-sectional views of another embodiment of the display device of the present invention;

FIG. 6 is a schematic view of the display device shown in FIG. 5A that is covered by the tape;

FIG. 7 is a flowchart of an embodiment of an assembly method of the display device of the present invention;

FIGS. 8A to 8G are schematic views of assembling the display device of the present invention.

### DETAILED DESCRIPTION OF THE PREFERRED EMBODIMENT

Embodiments of the present invention are to provide an alignment mark in a process of assembling a display device. The alignment mark is formed on a first substrate of a display panel or on a cover lens before the display panel is combined with a backlight module. On the other hand, an alignment hole is formed on the backlight module. It is helpful in combining the display panel with the backlight module by confirming the alignment mark through the alignment hole from the bottom of the backlight module. The display panel is preferred a liquid crystal display panel or may be other different kinds of panels use with the backlight module.

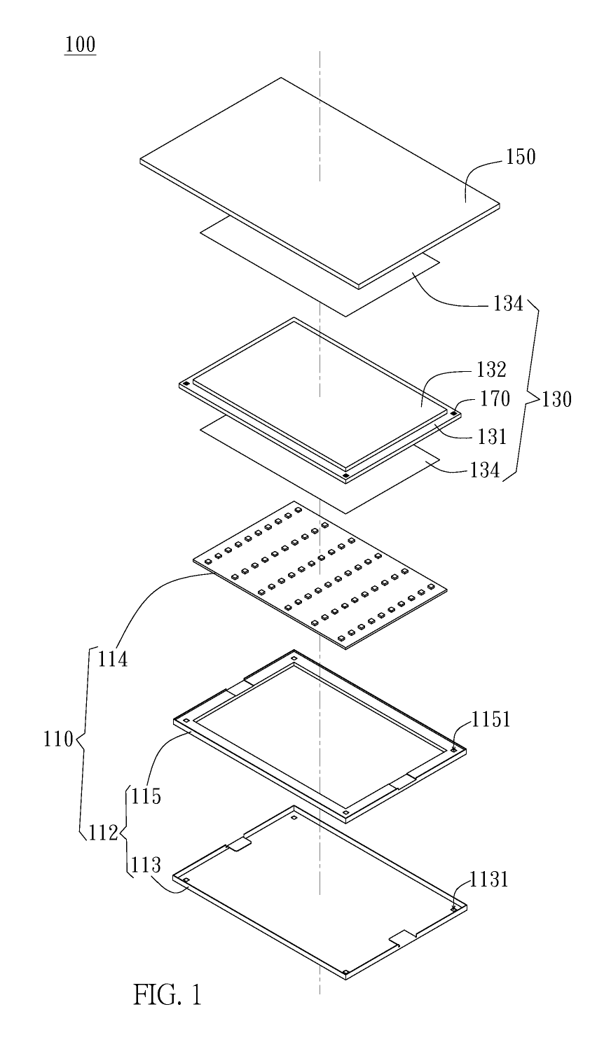

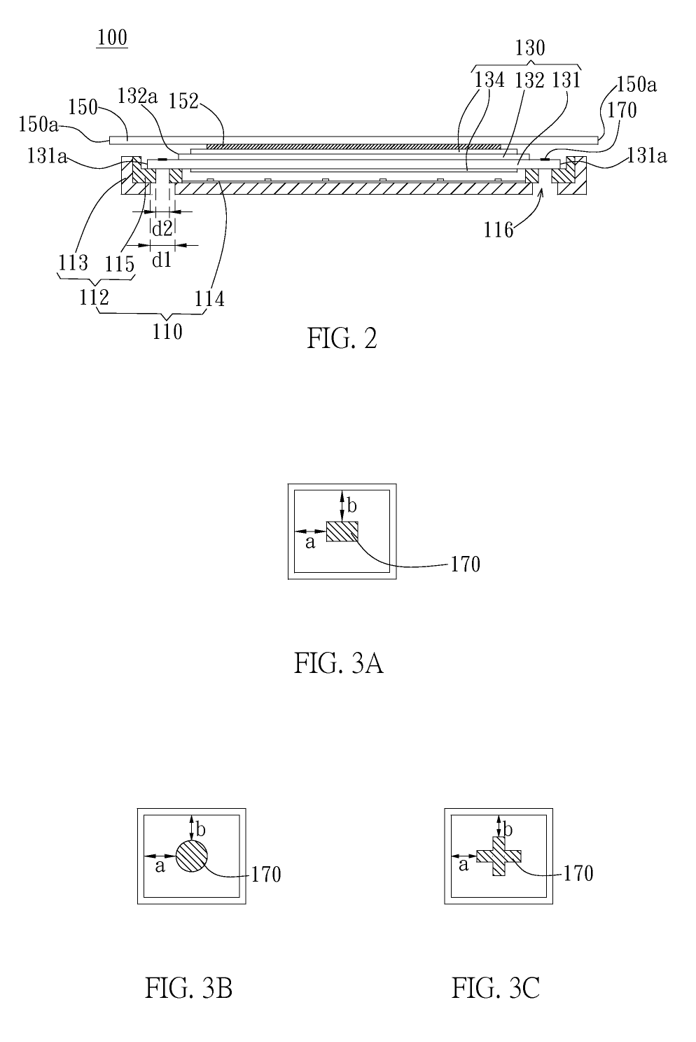

FIG. 1 is an exploded view of a display device 100 of the present invention. As shown in FIG. 1, the display device 100 includes a backlight module 110, a display panel 130, and a cover lens 150. The backlight module 110 has a backlight source 114 and a supporting frame 112, and an alignment hole is formed on the supporting frame 112. For example, the supporting frame 112 includes a metal frame 113 and a plastic frame 115 disposed in the metal frame 113. The metal frame 113 has a first alignment hole 1131, and the plastic frame 115 has a second alignment hole 1151. The first alignment hole 1131 and the second alignment hole 1151 communicate with each other and together form the alignment hole mentioned above, wherein the first alignment hole 1131 and the second alignment hole 1151 can have different diameters. As shown in FIG. 2, in a preferred embodiment, the diameter (d1) of the first alignment hole 1131 is larger than the diameter (d2) of the second alignment hole 1151, so that the confirmation of positions between the display panel 130 and the backlight module 110 can be completed by utilizing the second alignment hole 1151 with smaller diameter on the plastic frame 115 during aligning process. Besides, the inequality relation of the diameter can provide flexible production, avoiding the first alignment hole 1131 formed on the metal frame 113 and the second alignment hole 1151 formed on the plastic frame 11 from interfering aligning vision due to factors such as production tolerance or assembly tolerance. While in different embodiments, the diameter of the second alignment hole 1151 is adapted to be larger than the diameter of the first alignment hole 1131 based on requirement (i.e. aligning by the first alignment hole 1131 of the metal frame 113), or aligning the first alignment hole 1131 with the second alignment hole 1151 in a vertical direction and together form the alignment hole mentioned above (i.e. the diameter of the first alignment hole 1131 and the second alignment hole 1151 are the same). In addition, the supporting frame 112 can be merely composed of the metal frame 113 or the plastic frame 115; in this case, the alignment hole is individually formed by the first alignment hole 1131 or the second alignment hole 1151.

As shown in FIG. 1, the display device 130 is disposed on the backlight module 110 and includes a first substrate 131 and a second substrate 132 disposed on the first substrate 131. A display media layer (not shown), such as a liquid crystal layer, is disposed between the first substrate 131 and the second substrate 132. As shown in FIG. 1, an alignment mark 170 is formed on the first substrate 131 and near a corner of the first substrate 131. The alignment mark 170 is preferably formed on a surface of the first substrate 131 facing the cover lens 150, and is preferably formed together with the metal layer that serves as a signal circuit on the first substrate 131 during the same lithography process. However, in different embodiments, the alignment mark 170 can be formed on a surface of the first substrate 131 facing the backlight module 110. Besides, the alignment mark 170 corresponds to, in a projective manner, the first alignment hole 1131 and the second alignment hole 1151 in a direction perpendicular to the first substrate 131. In addition, polarized plates 134 can be disposed on outer sides of the first substrate 131 and the second substrate 132. The cover lens 150 covers on the display panel 130, i.e. the cover lens 150 covers on an outer side of the display panel 130 opposite to the backlight module 110. The cover lens 150 can be, for example, a touch module substrate or a protective substrate as the outermost layer of the display device.

Please refer to FIG. 2. FIG. 2 is a cross-sectional view of an embodiment of the display device 100 of the present invention. As shown in FIG. 2, the cover lens 150 is attached to the polarized plate 134 by a glue layer 152, wherein the glue layer 152 is preferred a transparent optical glue. Because the area of the cover lens 150 is larger than the area of the display panel 130, an outer edge 150a of the cover lens 150 will protrude beyond a side edge 131a of the first substrate 131 after the cover lens 150 covers the display panel 130. After the display panel 130 is combined with the cover lens 150, the display panel 130 will be disposed on the backlight module 110. As shown in FIG. 2, the alignment mark 170 is formed on the first substrate 131. On the other hand, the backlight module 110 has an alignment hole 116. The aforementioned first alignment hole 1131 and the second alignment hole 1151 together form the alignment hole 116, wherein a first diameter (d1) of the first alignment hole 1131 is larger than a second diameter (d2) of the second alignment hole 1151. As mention above, by this design, the aligning process can be performed by utilizing the alignment hole having smaller diameter. The design of alignment holes with different diameters can provide flexible production. As such, the alignment mark 170 (referring to the bottom view of FIG. 3A) is visible through the alignment hole 116 from the outer side of the backlight module 110, and the alignment mark 170 overlaps the alignment hole 116 within a vertical projecting region of the supporting frame 112. Therefore, when the alignment mark 170 totally falls into the alignment hole 116, or when a horizontal distance (a) and a vertical distance (b) between the alignment mark 170 and the periphery of the alignment hole are in a standard range (referring to FIGS. 8E-1 to 8E-3), it means that the aligning is accurate and the display panel 130 can be correctly disposed on the supporting frame 112. The assembly of the display panel 130 and the backlight module 110 can be completed by this design.

It is noted that the alignment mark 170 depicted in FIG. 1 preferably forms on three corners of the first substrate 131, but not limited to. In a preferred embodiment, two alignment marks located at two corners along a longer side of the first substrate can be provided for inspecting whether the horizontal distance and the vertical distance between the alignment mark and the periphery of the alignment hole are the same. The third alignment mark located at a corner along a diagonal direction can be provided for inspecting whether the horizontal plane of the display panel rotates. In addition to forming the alignment mark at the corner of the first substrate 131 as shown in FIG. 1, the alignment mark 170 can, on the premise that it will not interfere the circuit layout around the display panel and the location of electronic components, be formed on a protruding part (shown in FIG. 2) of the first substrate 131 beyond a side edge 132a of the second substrate 132, or formed on the cover lens 150. Besides, the first substrate 131 can have more or less alignment marks 170 according to requirements. (For example, two alignment marks 170 can be disposed along the diagonal direction).

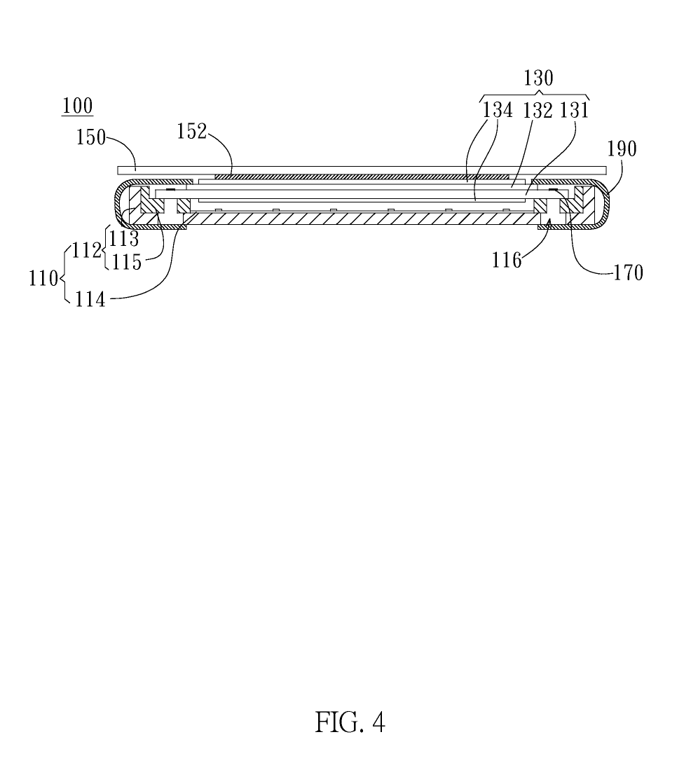

In addition to the square shaped alignment mark depicted in aforementioned embodiment, the alignment mark can be designed in different shapes. FIGS. 3A to 3C are schematic views of different embodiments of the alignment mark 170. As shown in FIG. 3A, the alignment mark 170 has a rectangular shape; as shown in FIG. 3B, the alignment mark 170 has a circular shape; as shown in FIG. 3C, the alignment mark 170 has a cross shape. Besides, the shape of an opening of the alignment hole is not limited to the rectangular shape; it can be the circular shape or other shapes. For material, the alignment mark is preferably made of a metallic material. When the display panel is aligned with the backlight module, the recognizability of the alignment mark can be elevated by inspecting the reflective light generated from metallic material of the alignment mark. Users can adapt the alignment mark that meets the whole recognition effect according to different shapes mentioned above. Besides, as shown in FIG. 4, after the combination of the display panel 130 and the backlight module 110 is completed, a tape 190 is further utilized to seal the alignment hole 116 from the outer side of the backlight module 110 for achieving dust-proof effect.

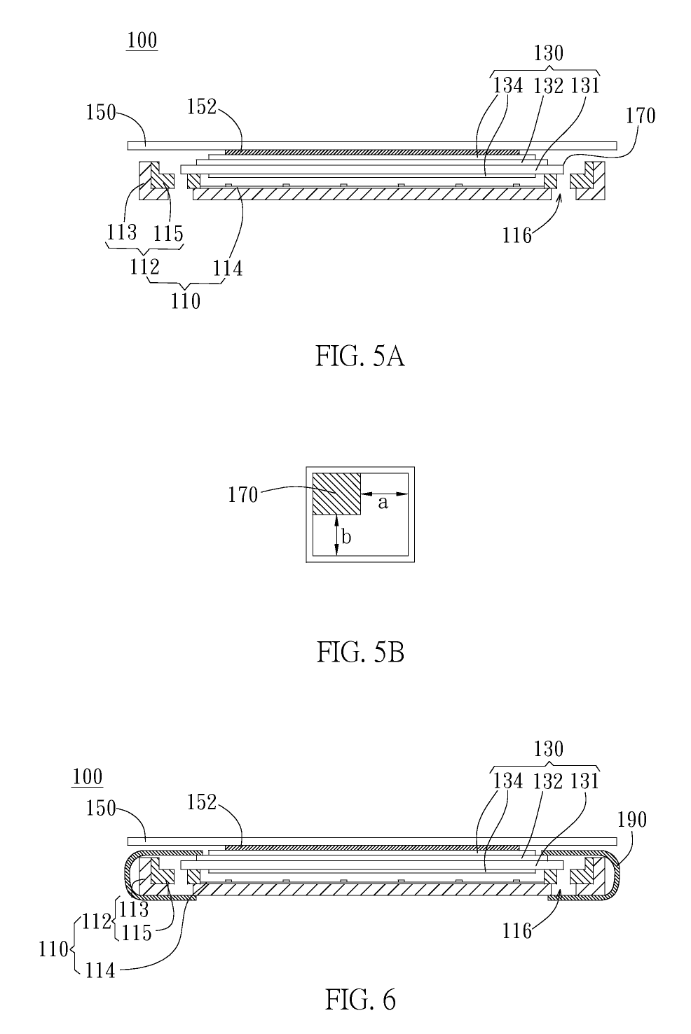

When the display panel has a smaller size, the corner of the display panel can serve as the alignment mark. FIGS. 5A is cross-sectional views of another embodiment of the display device 100 of the present invention. As shown in FIG. 5A, the alignment mark 170 is formed by the corner of the first substrate 131. In other words, at this situation, a part of corner (as shown in the bottom view of FIG. 5B) of the first substrate 131 is visible through the alignment hole 116 from the outer side of the backlight module 110, and the corner of the first substrate 131 at least partially overlaps the alignment hole 116 within the vertical projecting region of the supporting frame 112. As such, when a horizontal distance (a) and a vertical distance (b) between the corner of the first substrate 131 and the periphery of the alignment hole 116 are inspected within the standard range, it means that the aligning is accurate and the display panel 130 can be correctly disposed on the supporting frame 112. The assembly of the display panel 130 and the backlight module 110 can be completed by this design. Besides, as shown in FIG. 6, after the combination of the display panel 130 and the backlight module 110 is completed, the tape 190 is further utilized to seal the alignment hole 116 from the outer side of the backlight module 110 for achieving dust-proof effect.

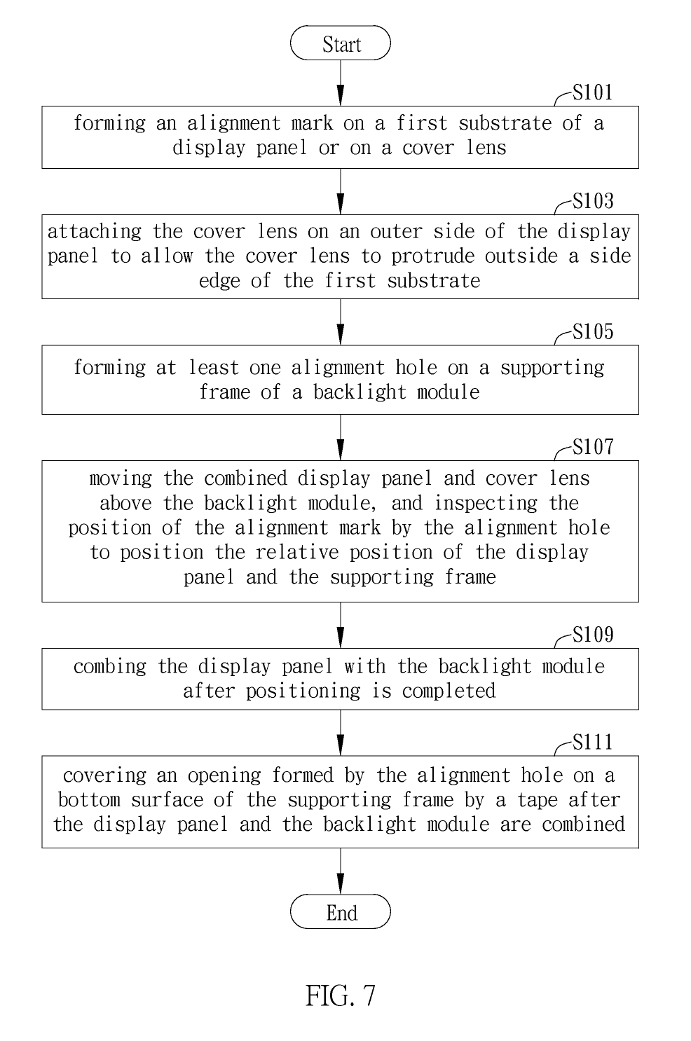

FIG. 7 is a flowchart of an embodiment of an assembly method of the display device of the present invention. As shown in FIG. 7, the assembly method of the display device includes, for example, the following steps: S101 forming an alignment mark on a first substrate of a display panel or on a cover lens.

S103 attaching the cover lens on an outer side of the display panel to allow the cover lens to protrude outside a side edge of the first substrate.

S105 forming at least one alignment hole on a supporting frame of a backlight module.

S107 moving the combined display panel and cover lens above the backlight module, and inspecting the position of the alignment mark by the alignment hole to position the relative position of the display panel and the supporting frame.

S109 combing the display panel with the backlight module after positioning is completed.

S111 covering an opening formed by the alignment hole on a bottom surface of the supporting frame by a tape after the display panel and the backlight module are combined.

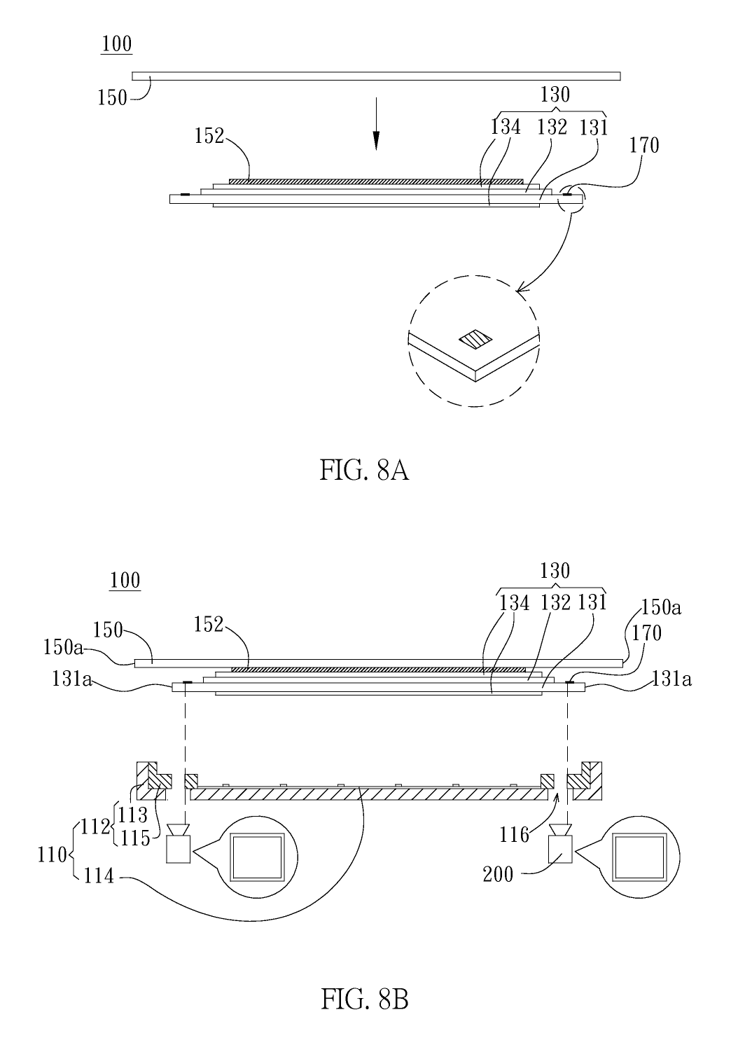

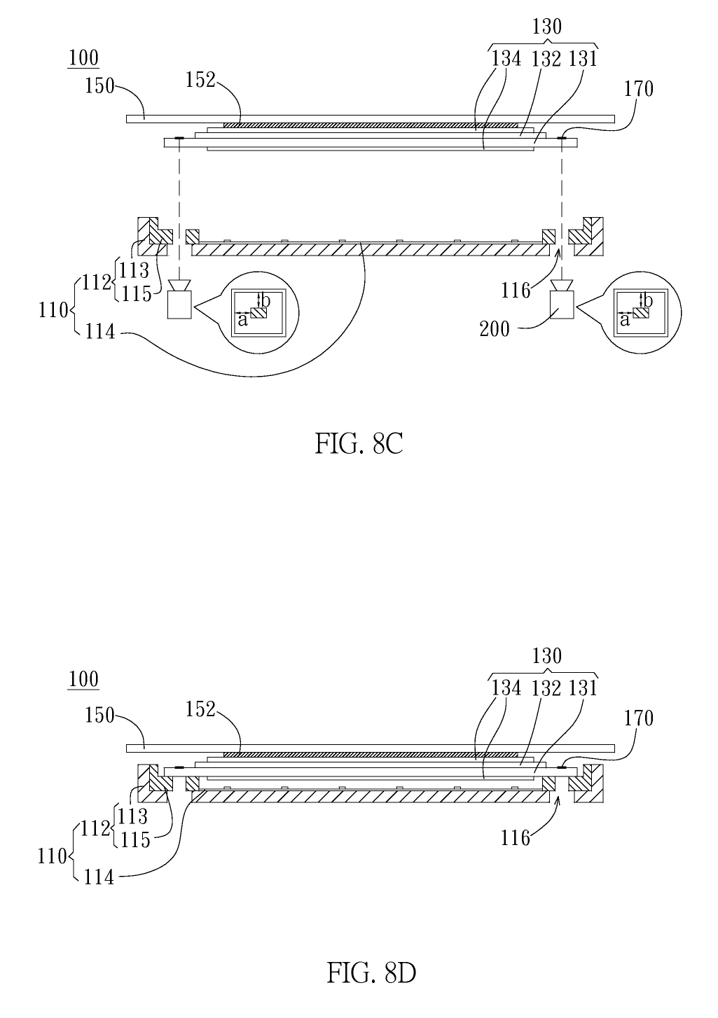

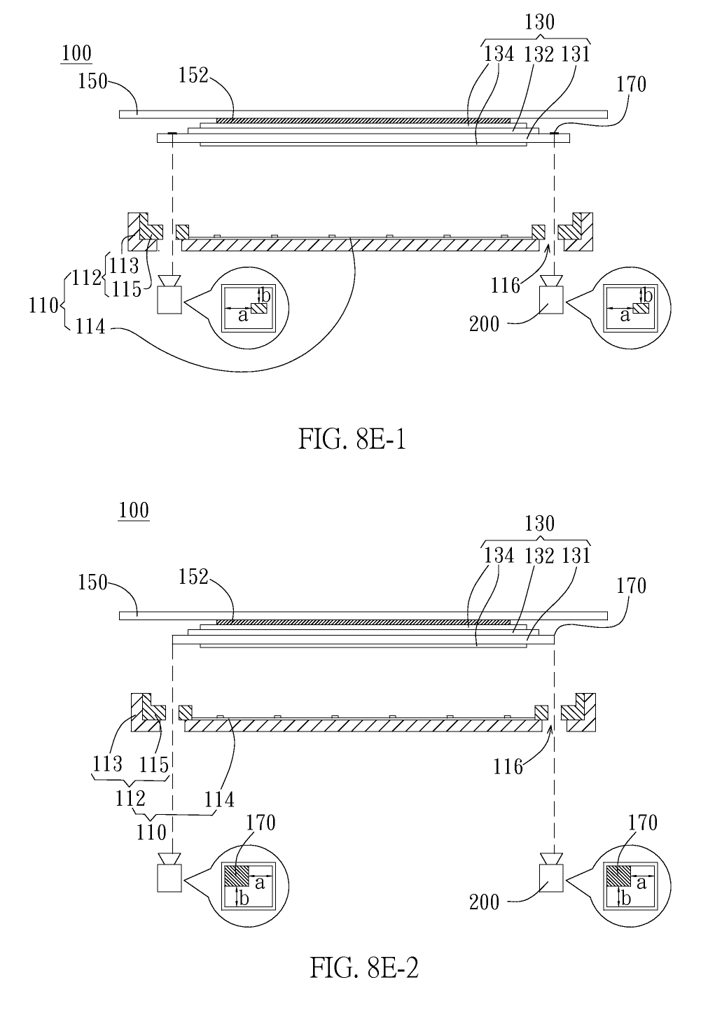

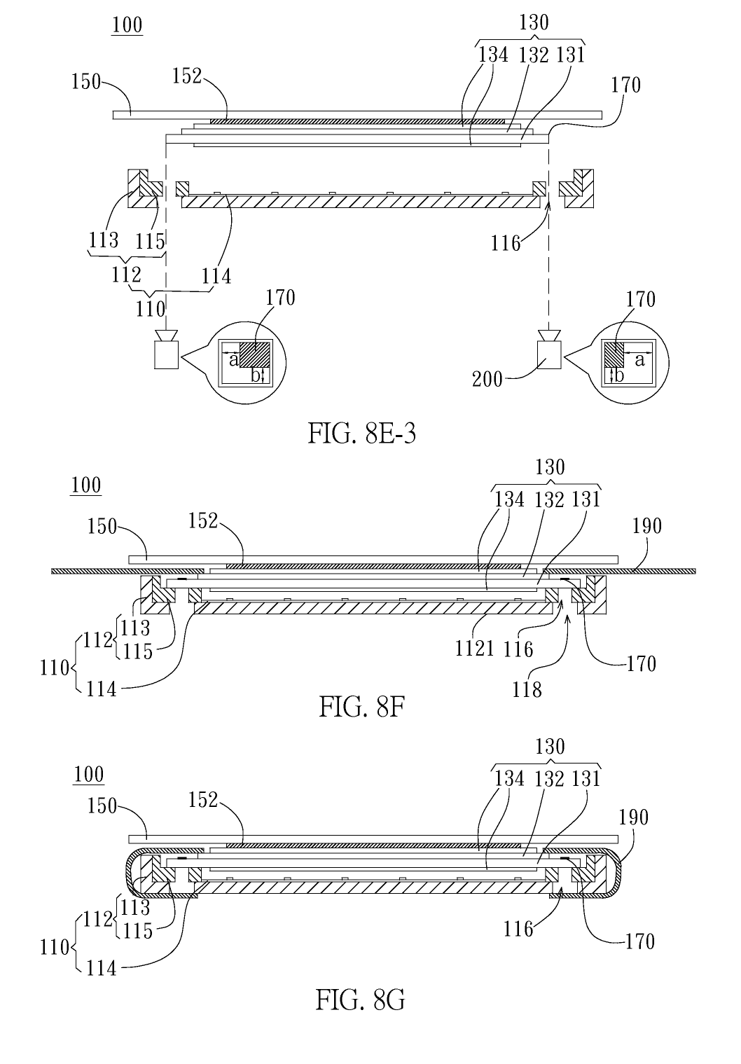

Please refer to schematic views of assembling the display device shown in FIGS. 8A to 8G. As shown in FIG. 8A, the alignment mark 170 is formed on the first substrate 131; then the glue layer 152 is distributed above the polarized plate 134, and the cover lens 150 is attached to the outer side of the display panel 130. However, it is not limited, the glue layer 152 can be distributed on the cover lens 150, and then the display panel 130 is attached to the cover lens 150. As shown in FIG. 8B, the cover lens 150 is attached to the display 130 panel, and the outer edge 150a of the cover lens 150 protrudes beyond the side edge 131 a of the first substrate 131.

In FIG. 8B, the combined display panel 130 and cover lens 150 is moved above the backlight module 110 to perform alignment between the display panel 130 and the backlight module 110. Two sides of the supporting frame 112 of the backlight module 110 have one alignment hole 116, respectively. A camera device 200 is disposed under the alignment hole 116 at the outer side of the backlight module 110. The camera device 200 couples to an external monitoring apparatus (not shown) in order to transmit aligning images to the monitoring apparatus for judging by users or machine. In an embodiment, as shown in FIG. 8B, it is found that the alignment mark 170 does not fall into the alignment hole 116 within the vertical projecting region of the backlight module 110 by the camera device 200, so that it can be determined that the relative position between the display panel 130 and the supporting frame 112 is not correct, and the position of the display panel 130 or that of the supporting frame 112 needs to adjust.

As shown in FIG. 8C, when the alignment mark 170 falls into the alignment hole 116 within the vertical projecting region of the supporting frame 112 and it can be determined that the relative position between the display panel 130 and the supporting frame 112 is correct; the aligning process is completed. As shown in FIG. 8D, the display panel 130 is combined with the backlight module 110.

In addition to disposing the alignment mark corresponding to the center position of the alignment hole, a predetermined standard range can be preset as aligning criteria according to process tolerances. As long as the position of the alignment mark within the projecting direction meets the standard range, the display panel can be combined with the backlight module. For example, the standard range can be defined by setting the distance between the alignment mark and the center position of the alignment hole to be less than 15% of radius of the alignment hole (or in another case, setting the distance less than one half of the length of the diagonal). In other words, the aforementioned step S107 that performs aligning process by the alignment hole can be S1072: confirming distances between each side of the alignment mark and a corresponding periphery of the alignment hole within the vertical projecting region of the supporting frame are smaller than the standard range. Particularly, if the aligning process is performed by the second alignment hole having a smaller diameter, then the S107 can be S1074: confirming at least a part of the alignment mark overlapping the second alignment hole within a vertical projecting region of the plastic frame. Please refer to different aligning ways shown in FIGS. 8E-1˜8E-3.

As shown in FIG. 8E-1, when the alignment mark 170 totally falls into the alignment hole 116, and the distance to the center of the alignment hole 116 meets the standard range (i.e. the horizontal distance (a) and the vertical distance (b) between the alignment mark 170 and the periphery of the alignment hole are in the standard range), the display panel 130 can be combined with the backlight module 110. For the case that takes the corner of the display panel as the alignment mark, as shown in FIG. 8E-2, when the corner at least partially overlaps the alignment hole 116 within the vertical projecting region of the supporting frame 112 and relative distances between the corner and the alignment hole 116 are the same, it can be determined that the relative position between the display panel 130 and the supporting frame 112 is correct; the aligning process is completed. As shown in FIG. 8E-3, when the corner at least partially overlaps the alignment hole 116 and relative distances between the corner and the center of the alignment hole 116 meets the standard range (i.e. the horizontal distance (a) and the vertical distance (b) between the corner and the periphery of the alignment hole fall in the standard range), the display panel 130 can be combined with the backlight module 110 for providing better alignment flexibility.

Following the description in FIG. 8D, the combined display device 100 is shown in FIG. 8F. Since the alignment hole 116 penetrates through the supporting frame 112, the opening 118 exists on a bottom surface 1121 of the supporting frame 112 after the display panel 130 and the backlight module 110 are combined. As such, after the combination of the display panel 130 and the backlight module 110 is completed, a tape 190 is utilized to cover the opening 118 formed by the alignment hole 116 on the bottom surface 1121 of the supporting frame 112. This design can prevent foreign matter from entering the display device 100 and the effect of dust-proof can be achieved. The aforementioned step of attaching the tape in S111 can be subdivided into S1112: attaching one end of the tape to the outer surface of the display panel facing the cover lens, and S1114: attaching the other end of the tape to the bottom surface of the supporting frame where the opening is located. At last, in an embodiment, as shown in FIG. 8G, one end of the tape 190 is attached to the surface of the second substrate 132 facing the cover lens 150. The other end of the tape 190 is attached to the bottom surface 1121 of the supporting frame 112 corresponding to the position where the opening is located to seal the opening 118. It is noted that attaching two ends of the tape 190 is not a fixed sequence, which can be adjusted according to conditions of process. By the alignment design, the position of the alignment mark can be confirmed by the alignment hole formed on the backlight module, and the accuracy of combining the display panel and the backlight module can be elevated; meanwhile, the assembly yield of the display device can be increased and damages to the display panel during manufacturing process can be reduced.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A display device, comprising:
a backlight module having a supporting frame, wherein at least one alignment hole is formed on the supporting frame;
a display panel disposed on the backlight module and having a first substrate;
a cover lens covering an outer side of the display panel opposite to the backlight module and protruding outside a side edge of the first substrate; and
an alignment mark formed on the first substrate or on the cover lens, the alignment mark at least partially overlapping the alignment hole within a vertical projecting region of the supporting frame.

2. The display device of claim 1, wherein the alignment mark is visible through the alignment hole from the outer side of the backlight module.

3. The display device of claim 1, wherein the supporting frame comprises:
a metal frame having a first alignment hole; and
a plastic frame disposed in the metal frame and having a second alignment hole,
wherein the first alignment hole and the second alignment hole communicate with each other and together form the alignment hole.

4. The display device of claim 3, wherein the first alignment hole has a first diameter, and the second alignment hole has a second diameter, and the first diameter is larger than the second diameter.

5. The display device of claim 1, further comprising a tape, the alignment hole forming an opening on a bottom surface of the supporting frame, the tape covering the opening from the outer side of the backlight module.

6. The display device of claim 5, wherein one end of the tape is attached to an outer surface of the display panel facing the cover lens, and the other end of the tape is attached to the bottom surface of the supporting frame where the opening is located.

7. The display device of claim 1, wherein the alignment mark is disposed on a surface of the first substrate facing the cover lens, and the alignment mark is made of a metallic material.

8. The display device of claim 1, wherein the alignment mark is formed by means of a corner of the first substrate.

9. The display device of claim 1, wherein the alignment mark totally falls into the alignment hole within the vertical projecting region of the supporting frame.

10. The display device of claim 1, wherein the display panel further comprises a second substrate and a display media layer, the display media layer is disposed between the first substrate and the second substrate, the first substrate has a protruding part protruding beyond a side edge of the second substrate, and the alignment mark is located on the protruding part.

11. The display device of claim 1, wherein the cover lens is a touch module substrate.

12. An assembly method of a display device, comprising:
(a) forming an alignment mark on a first substrate of a display panel or on a cover lens;
(b) attaching the cover lens on an outer side of the display panel to allow the cover lens to protrude outside a side edge of the first substrate;
(c) forming at least one alignment hole on a supporting frame of a backlight module;
(d) moving the combined display panel and the cover lens above the backlight module, and inspecting the position of the alignment mark by the alignment hole to position the relative position of the display panel and the supporting frame; and
(e) combing the display panel with the backlight module after positioning is completed.

13. The assembly method of claim 12, further comprising: (f) covering an opening formed by the alignment hole on a bottom surface of the supporting frame by a tape after the display panel and the backlight module are combined.

14. The assembly method of claim 13, wherein the step (f) comprises:
(f1) attaching one end of the tape to an outer surface of the display panel facing the cover lens;
(f2) attaching the other end of the tape to the bottom surface of the supporting frame where the opening is located.

15. The assembly method of claim 12, wherein the step (d) comprises confirming the alignment mark totally falling into the alignment hole within a vertical projecting region of the supporting frame.

16. The assembly method of claim 12, wherein the step (d) comprises confirming distances between each side of the alignment mark and a corresponding periphery of the alignment hole within a vertical projecting region of the supporting frame are smaller than a standard range.

17. The assembly method of claim 12, wherein the supporting frame comprises a metal frame and a plastic frame, the metal frame has a first alignment hole, the plastic frame has a second alignment hole communicating with the first alignment hole, the first alignment hole and the second alignment hole together form the alignment hole, and a first diameter of the first alignment hole is larger than a second diameter of the second alignment hole, the step (d) comprises confirming at least a part of the alignment mark overlapping the second alignment hole within a vertical projecting region of the plastic frame.
